(19) United States
(12) Patent Application Publication
(10) Pub. No.: US 2013/0067596 A1
(43) Pub. Date: Mar. 14, 2013

(54) DETECTION FILTER

(71) Applicants: Constantine Siourthas, Hawthorn East (AU); Bjarne Staugaard Matzen, Glen Waverley (AU)

(72) Inventors: Constantine Siourthas, Hawthorn East (AU); Bjarne Staugaard Matzen, Glen Waverley (AU)

(73) Assignee: FMT Worldwide Pty Ltd, Melbourne (AU)

(21) Appl. No.: 13/414,617

(22) Filed: Mar. 7, 2012

Related U.S. Application Data
(63) Continuation of application No. 12/616,660, filed on Nov. 11, 2009, now abandoned.
Application No. 12/616,660 is a continuation of application No. PCT/AU2007/001929, filed on Dec. 13, 2007.
Application No. PCT/AU2007/001929 is a continuation of application No. 11/747,705, filed on May 11, 2007.

(30) Foreign Application Priority Data
May 11, 2007 (AU) 2007202119

(51) Int. Cl. G06F 21/24

(52) U.S. Cl. 726/28

(57) ABSTRACT

A detection filter installed in an application server including a secure application is disclosed. In one embodiment, the filter includes a rules engine for receiving request data representing an access request for the secure application from a user. The engine applies at least one risk condition rule to the request data to generate a risk probability level, and detects at least one fraud condition when the risk probability level exceeds a threshold level, before passing the access request to the secure application.

### RELATED APPLICATIONS

This application is a continuation, and claims the benefit under 35 U.S.C. §120 of U.S. patent application Ser. No. 12/616,660 filed on Nov. 11, 2009, which is hereby incorporated by reference. Application Ser. No. 12/616,660 is a continuation, and claims the benefit under 35 U.S.C. §§120 and 365 of PCT Application No. PCT/AU2007/001929, filed on Dec. 13, 2007, which is hereby incorporated by reference. The PCT application also claimed priority to and the benefit of Australian Patent Application No. 2007202119 filed on May 11, 2007 and U.S. patent application Ser. No. 11/747,705 filed on May 11, 2007, both of which are incorporated herein by reference.

### FIELD

The present invention relates to a system for detecting possible fraudulent activity during an access request process in an online environment, and in particular to a detection filter that can be used to detect a fraud condition or perform pre-processing on an access request.

### BACKGROUND

Current systems for protection against fraud in online environments are deficient. Web server systems currently employ authentication systems to authenticate users when they request access to connect to and use server applications. The authentication systems seek to determine that an access request is being made by an authorised user, e.g. on the basis of a unique username and password combination or some other unique authentication data submitted (e.g. biometric data). However no attempt is made to determine if the data submitted indicates the authentication data has been compromised or another party is fraudulently using the authorised parties' data or access privileges before the connection to the server application is allowed.

Online banking systems, for example, authenticate users, establish a connection session and allow transactions with an Internet banking application to be completed during the session; fraud detection is only performed subsequently by back-end analytic systems. The analytic systems receive transaction data of the session and process the data for comparison with pattern data representing possible fraudulent conditions. This is clearly unsatisfactory as a user's account can be compromised before any fraud is detected. Suspicious activities or other undesirable conditions may not be detected until identified by the back-end analytic software, i.e. after the event has occurred.

### SUMMARY

One aspect of the invention addresses the above, or at least provides a useful alternative.

Another aspect of the present invention is a fraud detection filter installed in an application server including a secure application, the filter including a rules engine for receiving request data representing an access request for the secure application from a user, and applying at least one risk condition rule to the request data for generating a risk probability level, and detecting at least one fraud condition when the risk probability level exceeds a threshold level, before passing the access request to the secure application.

Another aspect of the present invention is a management server for generating an interface to adjust and set the at least one risk condition rule.

Another aspect of the present invention is a filter system including the filter and the management server.

Another aspect of the present invention is an application server including a secure application for access by a user and the fraud detection filter.

Another aspect oft he present invention is a process for detecting a fraud condition, performed by an application server, including:
receiving request data representing an access request from a user for a secure application of the application server;
applying at least one risk condition rule to the request data for generating a risk probability level; and
detecting the fraud condition when the risk probability level exceeds a threshold level, before granting access to the secure application.

Another aspect of the present invention is a filter installed in an application server including a application, the filter including a rules engine for receiving request data representing an access request for the application from a user, and applying at least one condition rule to the request data for generating a probability level, and detecting at least one condition when the probability level exceeds a threshold level, before passing the access request to the application.

Another aspect of the present invention is a process for detecting a condition, performed by
an application server, including:
   receiving request data representing an access request from a user for an application of the application server;
   applying at least one condition rule to the request data for generating a probability level; and
      detecting the condition when the probability level exceeds a threshold level, before granting access to the application.

### DESCRIPTION OF THE DRAWINGS

Embodiments of the invention are further described, by way of example only, with reference to the accompanying drawings.

FIG. 1 is a schematic diagram of a filter system arranged in a condition of use.

FIG. 2 is a schematic diagram of the filter system showing modules of an application server.

FIG. 3 is a flow chart of a filter process of the filter system.

FIG. 4 is a flow chart of part of the filter process showing process blocks.

FIG. 5 is a schematic diagram of the filter system showing modules of a pre-processing filter and of a management server.

FIG. 6 is an image of a user interface showing user options.

FIG. 7 (FIGS. 7-1 and 7-2) is an image of a user interface generated by the management server of the filter system showing example process blocks.

### DETAILED DESCRIPTION

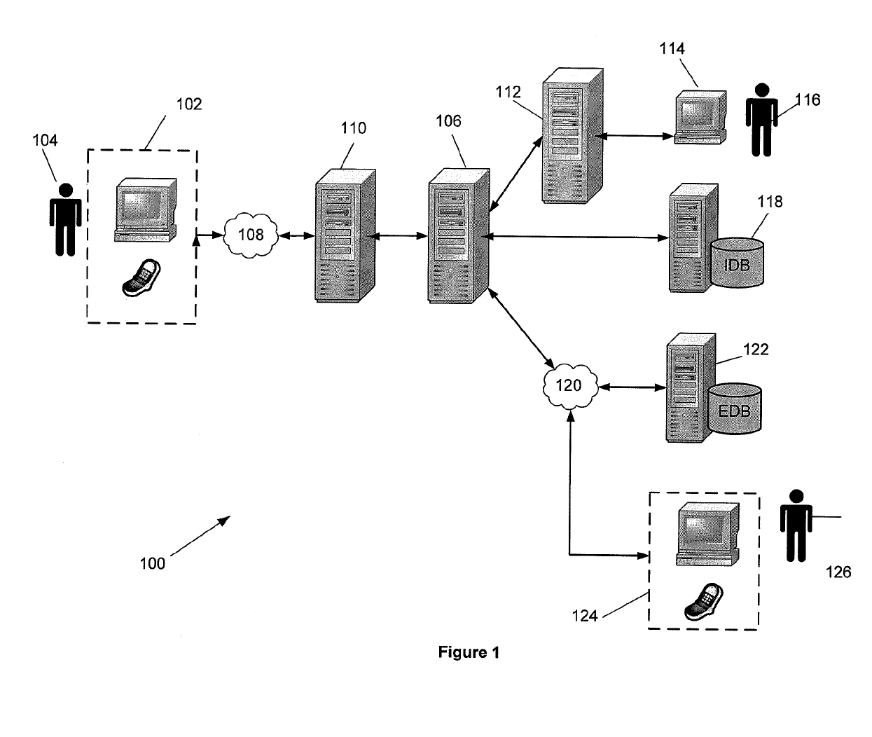

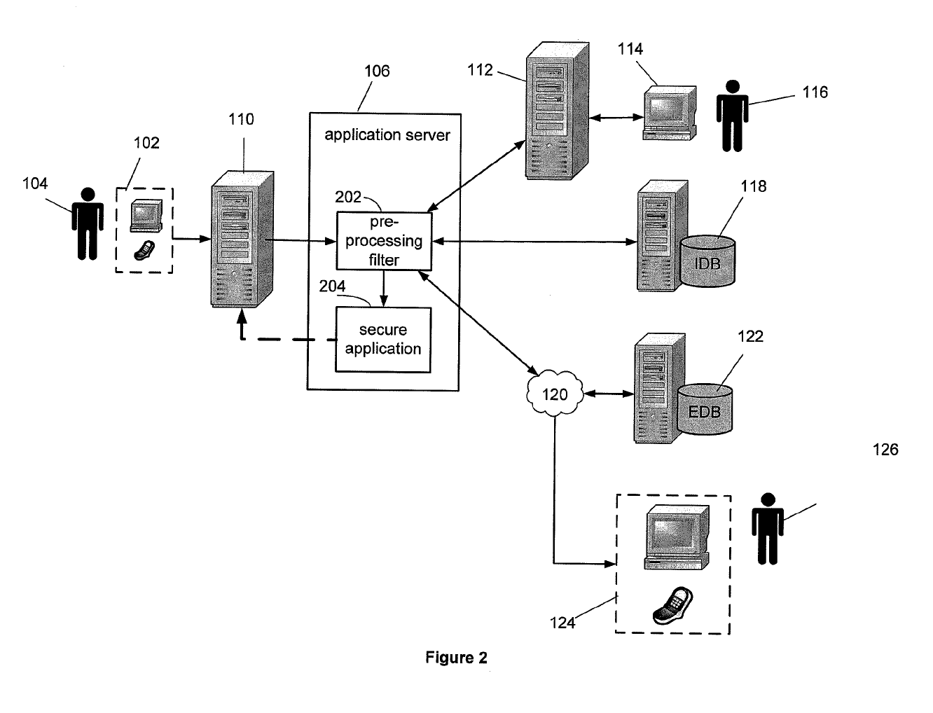

A fraud detection system in the form of a filter system 100, as shown in FIG. 1, filters an access request from a user device 102 of a user 104 who is attempting to access a secure application 204 on an application server 106. The user device 102 accesses the application server 106 via a first data network 108 (e.g. the Internet) and an associated network server 110 (e.g. a Web server). The access request is filtered in the filter system 100 by a pre-processing filter 202 that is installed or embedded in the application server 106, as shown in FIG. 2, before access is granted to the secure application 204.

The pre-processing filter 202 provides a real-time decision engine which performs blocking and alerting process actions depending on a risk probability level determined from the access request. The access request is in accordance with standard communication protocols, such as the suite of IP protocols, and may be a HTTP Get request. The action taken by the pre-processing filter 202, and the treatment of data obtainable from the access request, is configurable via a management server 112. The management server 112 is controlled from a management console 114 securely in communication with the management server 112, which is operated by an administrator 116. The administrator 116 may be the owner of the application server 106 and secure application 204 (e.g. a bank owning an on-line banking application), or a third party security administrator providing security services to the owner of the secure application 204. The administrator 116 may conveniently configure and adapt the pre-processing filter 202 using the management console 114. The pre-processing filter 202 has access to an internal database 118 of the application server 106, for securely storing relevant filter data, and to a second data network 120 (e.g. an intranet or the Internet), by which one or more external databases 122, a client device 124 (of a person (i.e. client) 126 authorised by the owner to monitor performance of the filter 202) and the user devices 102 may be accessed.

The internal database 118 is used by the pre-processing filter 202 to keep a secure record of filter data, such as a history of past access requests and other data that may be deemed relevant by the administrator 116. By locating the filter 202 with the secure application 204 in the application server, the filter 202 is able to rely upon and use the same data and procedure calls as the secure application 204. The filter 202 can therefore access account data and access history data for individual user accounts on a per user level.

The pre-processing filter 202 may access the external database 122 to draw on third party information (such as published Internet Protocol address blacklists), or to deliver report data into a case management file. Report data may also be sent by the pre-processing filter 202 and the management server 112 to the client device 124 for real-time reporting by the filter system 100: for example, a person 126 may be alerted when the access request originates from a certain undesirable range of IP addresses.

The pre-processing filter 202 may access the user device 102 via the web server 110 and the first data network 108 to seek a second authentication factor. For example, the filter system 100 may request an additional user/password from the user 104, or submission of an encoded token sent by SMS to a mobile telephone, when certain access request characteristics, i.e. a fraud condition, is detected by processing of the access request by the pre-processing filter 202. In other words, a two factor authentication process can be invoked that needs to be satisfactorily completed before access is granted.

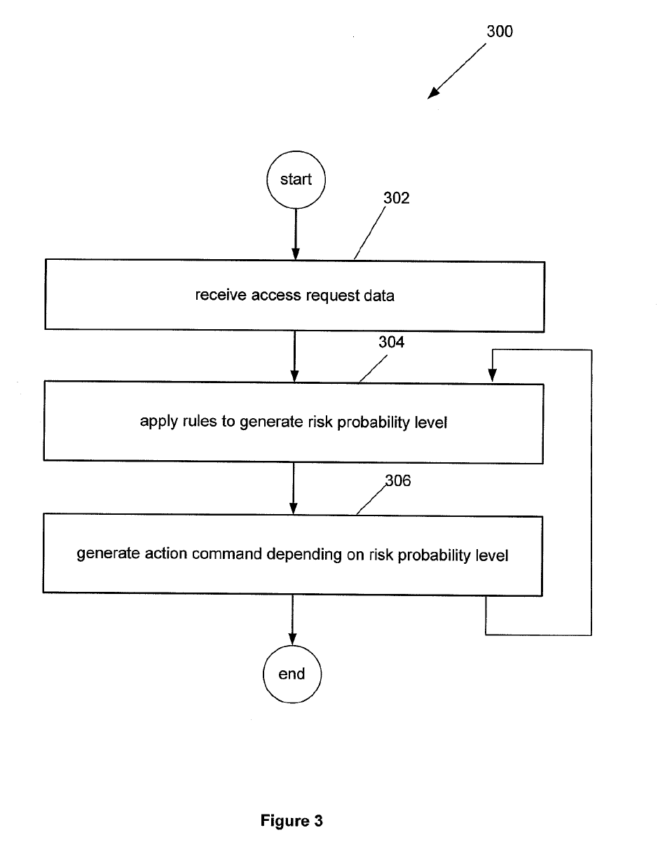

A filter process 300 performed by the pre-processing filter 202 commences with the pre-processing filter 202 receiving an access request sent by the user device 102 requesting access to the secure application 204 for the user 104 (step 302 in FIG. 3). Following reception of the access request, the pre-processing filter 202 then applies rules to the data of the request to generate the risk probability level, i.e. a measure representative of the probability that the access request originates from a risky, or fraudulent, user 104. Once the risk probability level is generated in step 304, the pre-processing filter 202 generates an action command depending on the level of the risk probability. For example, if there is a very low risk probability (determined at step 304) the action command (generated in step 306) may allow access to the secure application 204. On the other hand, if the risk probability is above an acceptable level, the action command may block access to the secure application 204 and/or alert the client 126 using a message sent to the client device 124. The filter process may continue by repeating the application of the rule/s (step 304) and the generation of a consequent action command (step 306) depending on the number of steps in the pre-processing filter 202. The owner 116 configures how many rules are applied and how many action commands are generated. The filter process ends once no further rules remain to be applied. For example, an access request including access request data may be received (at step 302) from an IP address located in an untrustworthy Russian city. The pre-processing filter 202 then applies a rule that considers the risk probability level associated with IP addresses from certain geographic locations, and assigns a relatively high risk level to this access request at step 304. Consequently, in step 306, the pre-processing filter 202 generates an action command to block the access request from the secure application 204 and a second action command to retain a record of this access request in the internal database 118.

Typical access request data, as analysed in step 302 of the filter process 300) may include one or more of the following characteristics of interest which may indicate a risk probability associated with the access request:
(a) Originating IP address,
(b) Browser type and version
(c) Connection speed
(d) Access from a known compromised IP address
(e) Access from public hot-spot
(f) Access via satellite
(g) Secure application data submitted with the request (such as account number, amounts, address changes etc.)

The rules applied in step 304 relate to the access request data. Typical rules may include:
(a) Checking the originating country for the IP address is not a high risk or black listed country
(b) Impossible travel speed between current originating IP address and previous originating IP address
(c) Checking the originating IP address against known black lists
(d) Checking for money transfers to suspicious names. The filter 202, being part of the application server 106, applies rules to every access request made during a transaction session, even once a user has been given access privileges to the secure application 104. Accordingly, the rules are tailored for the specific application as required.
(e) Checking if browser characteristics have changed from a previous request

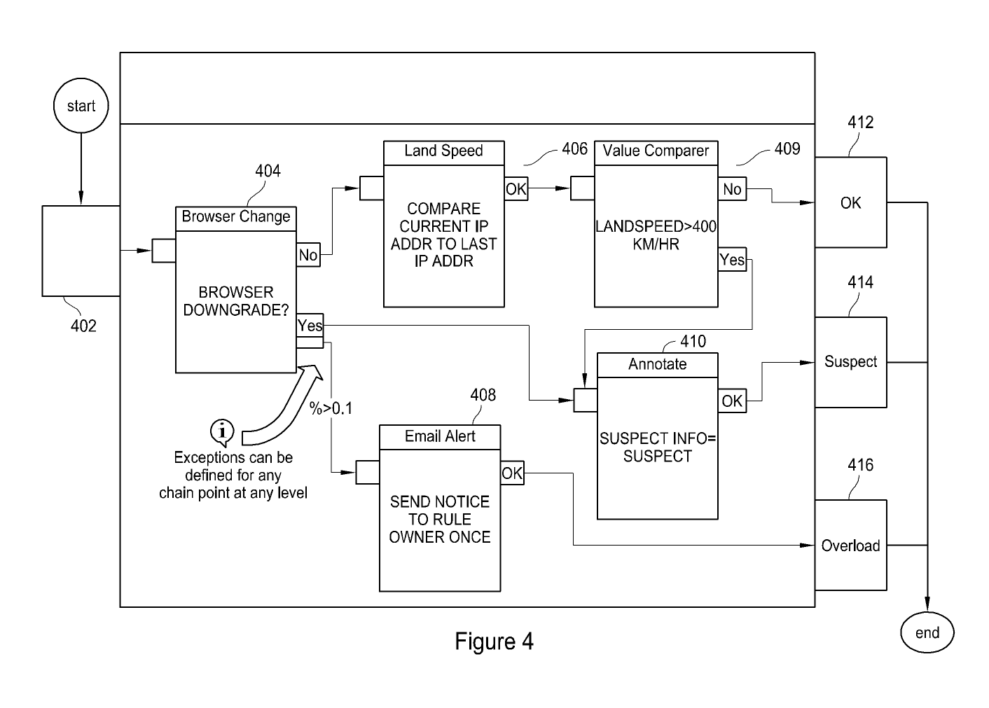

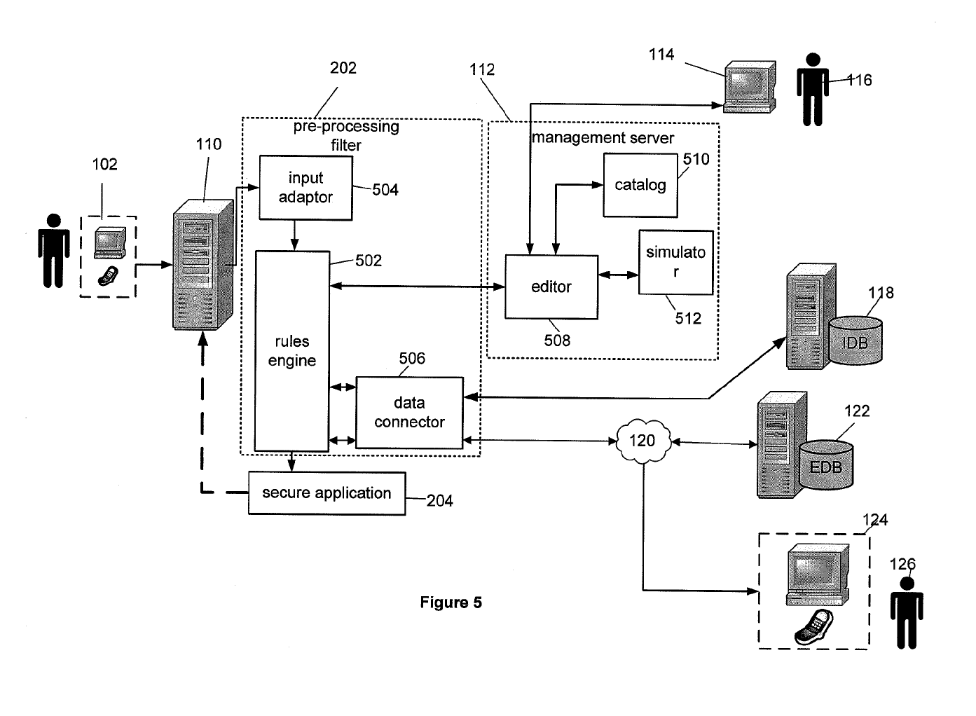

In an example of the filter process 300, the access request data is received in step 402 (shown in FIG. 4). In this example, the access request is for a Web application, and the access request data includes: data representative of the version of the Web browser used on the user device 102; and data representative of the IP address used by the user device 102. Furthermore, this user 104 (identified by a username and password combination in the access request data) has previously interacted with the pre-processing filter 202, and thus historical data of previous access requests for other sessions is stored in the internal database 118. The first rule applied by the pre-processing filter 202 is a browser change rule (in step 404): if the browser version of the present access request has not changed since the previous access request, or is a more recent version, no action is taken by the pre-processing filter 202, and the filter process 300 continues to apply a second rule, being a land speed rule (in step 406). If, on the other hand, a downgrade of the browser version is detected (in step 404), a non-zero risk probability level is generated, and the pre-processing filter 202 generates an action command depending on the level of the fraud probability. If the risk probability level is high, corresponding to receipt of a percentage (say greater than 0.1%) of transactions, i.e. access requests, for a period that represent a browser downgrade, then an email alert action command is generated which leads to an email alert notice to be sent once to the client device 124.

If the risk probability level generated by the browser change rule (in step 404) is medium or low, the pre-processing filter 202 continues with an annotation action command being generated in step 410. The annotation action command tags record data in the internal database 118 to indicate that the access request data is suspect or dangerous (i.e. has a corresponding risk probability level). If no browser downgrade was detected in step 404, a land speed rule (step 406) and a value comparer rule (step 408) are used by the pre-processing filter 202 to determine whether the present IP address is at a time and location which is greater than 400 km/h from the previous IP address and location (i.e. that a user 104 would have had to have travelled at least 400 km/h to move between the previous IP address location and the current IP address location). If the land speed is less than 400 km/h, a low fraud probability is generated, and the pre-processing filter 202 generates an action command indicating that the access request data is “ok”, and thus grants access to the secure application 204 (step 412). If, on the other hand, the user 104 appears to have travelled faster than 400 km/h, an action command is issued (at step 410) to annotate the relevant record in the internal database 118 indicating that the access request is suspect, but nonetheless allowing access to the secure application at step 414. This could also result in a case being created by generating and storing case record data in the management server as part of a case management system or two factor authentications can be requested.

If continuous occurrences of browser downgrades are found to be greater than 0.1% of all access requests received from all users over a period of time, an email alert action command (step 408) is executed to notify the administrator 116 that too many potential cases are being created and the pre-processing filter 202 executes an overload action command (step 416). This step allows the administrator to avoid overloading personnel that follow up fraud cases in the case management system. This can be an important step when new rules are being tested for the first time.

Each of the steps 404, 406, 408, 410 in the example process of FIG. 4 is in the form of a process block. Steps 304 and 306 of the filter process may be represented as a series of process blocks arranged such that filter rules are applied to the access request data and resultant action commands are generated.

The filtering process 300 is performed by a rules engine 502 in the pre-processing filter 202 as shown in FIG. 5. The rules engine 502 executes action commands relating to the customer devices 124 and the user device 102.

The access request data is received in the pre-processing filter 202 by an input adaptor 504 which translates the access request data from a variety of formats into a format recognised by the rules engine 502. For example, the input adaptor 504 can accept access requests for Web services, http services and java APIs with the input being in a format corresponding to CSV, XML and/or a messaging system (e.g. IBM MQ Series).

The rules engine 502 accesses the internal database 118 via a data connector 506 thus providing access to historical access request data and also has the ability to access data on the internal network during a user session with the secure application or via the Internet using the second data network 120. The rules engine 502 accesses and writes to the external database 122 via the second data network 120 using the same data connector 506 or a different data connector.

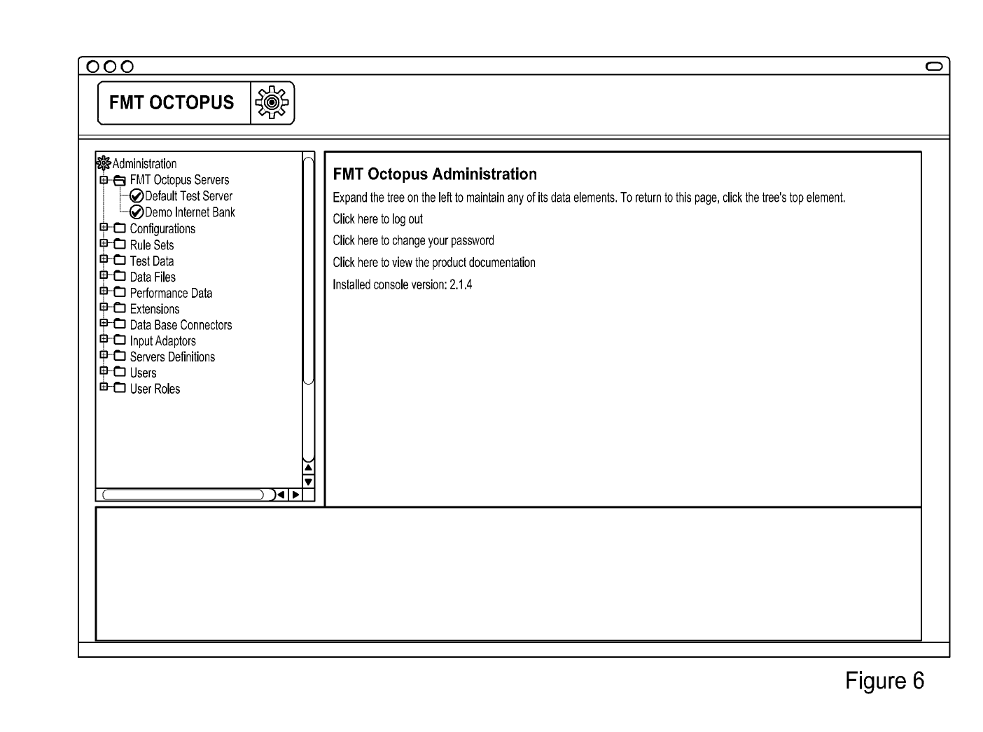

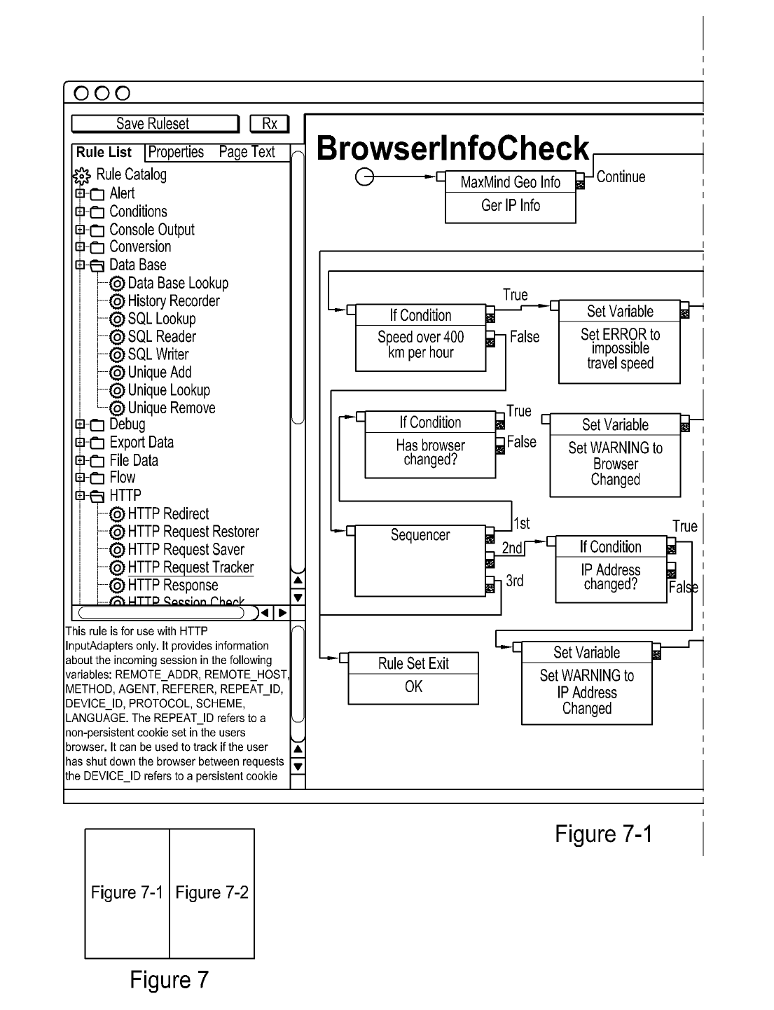

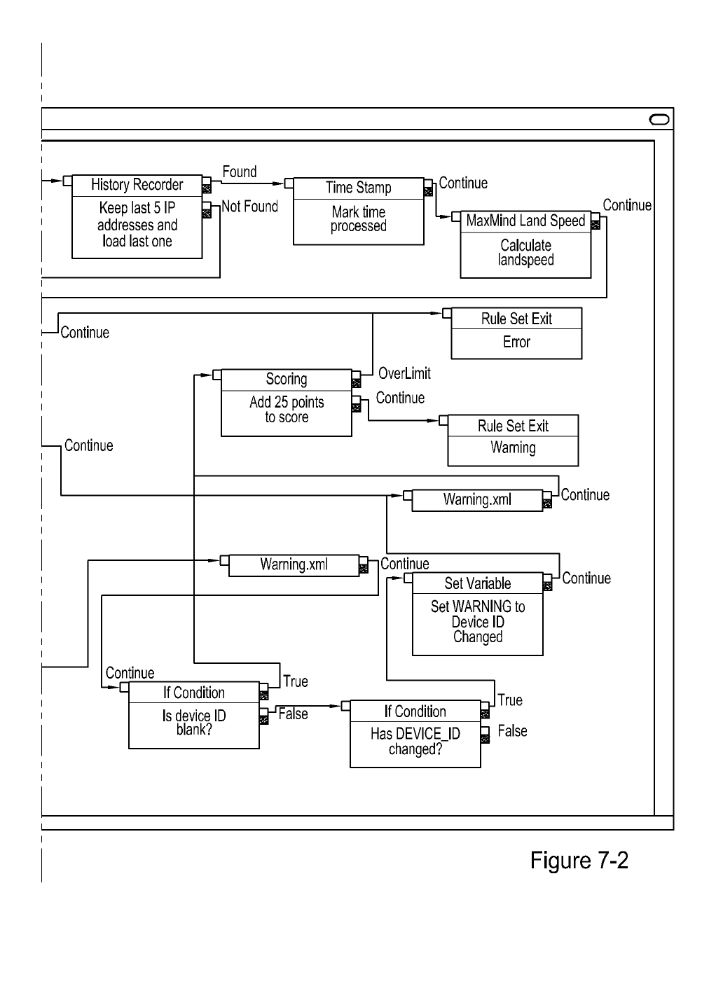

The specific arrangement or configuration of the rules engine 502 (e.g. specific risk probability levels, and specific action commands) are selected by the administrator 116 using an editor 508 of the management server 112. The editor 508 is controlled by a user interface on the management console 114, a screen shot of which is shown in FIG. 6. A further screen shot, shown in FIG. 7, is a graphic representation of a plurality of process blocks which constitute the steps to be taken by the filter process 300 in an example configuration of the rules engine 502. The visual interface to the editor 508 advantageously allows rapid, convenient and error-free configuration and re-configuration of the particular filter process 300 performed by the pre-processing filter 202.

The process blocks which are available to be used in the rules engine 502 are stored in a rules catalogue 510. New rules may conveniently be updated from a third party provider of data security products (e.g. over the Internet) or created ad-hoc by the administrator 116 using a process block creator in the editor 508. The set-up of the rules engine 502 is thus performed with an easy-to-use graphical interface and is highly flexible and adaptable to the needs of the owner 116 and the customer 126.

Example process blocks in the catalogue 510 include:
(a) Database access rules
(b) SMS alert rules
(c) IP address to location lookups
(d) Reverse DNS block list lookup rules
(e) Text manipulation rules

The process blocks fall into one of three categories:
1. data analysis process blocks;
2. rule application process blocks; and
3. action command process blocks.

The data analysis process blocks extract data from the data submitted by the user, and perform manipulations of the data. For example, the data analysis process blocks may concatenate string data, access white or black-list data, retrieve historical data from the internal database 118, access geo-spatial data relating to an Internet Protocol address of the access request, generate data representing calculations of land speed/deviations/amounts etc, and generate analytical data based on patterns in the data submitted by the user (e.g. click path, payment patterns).

The rule application process blocks control the process flow of the fraud detection filter. For example, a rule application process block may compare data drawn from submissions by the user 104 to a constant value, or to data drawn from other submissions. A rule application process block may also execute policies in a loop, or in a sequence, or may exit a sequence.

The action command process blocks generate command data to be transmitted to external systems. For example, an action command process blocks may log selected data or add a case to a case management system. An action command process blocks may also generate alerts (e.g. SMS, email) for the user 104 or the customer 126 or reject an access request.

A process block may also consist of a number of subsidiary process blocks linked so as to create a single process block.

When creating and/or editing a series of process blocks to control processing of the rules engine 502, the administrator 116 may also test the processing of the arrangement in an off-line environment (i.e. before running the new process in the rules engine 502) using a simulator 512. The simulator 512 allows the proposed filter process to be tested and observed in operation. The graphical user interface which displays the process blocks (e.g. as shown in FIG. 7) also graphically indicates the flow of the process during operation, thus enabling the administrator 116 to clearly visualise the operation of the proposed process.

The pre-processing filter 202 may be implemented using software code written in a computer program language, such as Java, running on a server engine (e.g. JSP) and the application server 106 may be in the form of a server product such as J2EE. The management server 112 may be a J2EE server. Alternatively, the pre-processing filter 202 and management server 112 may be implemented at least in part by dedicated hardware circuits, such as ASICs and FPGAs, to further enhance processing speed, particularly if processing of the engine is not to be reconfigured regularly.

The logical implementation of the rules engine 502 is in the form of a multi-threaded design which provides high speed filtering. High speed filtering is used so that the user 104 does not notice an appreciable delay when accessing the secure application 204 via the pre-processing filter 202 (e.g. if the access request is granted).

The external database 122 includes corporate databases, geospatial data, web services and black lists (e.g. OFAC, SpamHaus, Hunter, Aristion, NetEconomy, and SearchSpace).

The pre-processing filter 202 and the management server 112 may be implemented on the same server as the secure application, or the management server 112 is separate as described above. The filter 202 is placed before the application 204 on the application server so as to provide access to the same session data and procedures as the secure application 204.

Many modifications will be apparent to those skilled in the art without departing from the scope of the present invention as herein described with reference to the accompanying drawings.

1. A filter installed in an application server including a secure application, the filter comprising a rules engine configured to i) receive request data representing an access request for the application from a user, ii) apply at least one condition rule to the request data for generating a probability level, and iii) detect at least one condition when the probability level exceeds a threshold level, before passing the access request to the application.

2. A filter as claimed in claim 1, wherein the rules engine is further configured to access at least one of: past session data for the user in applying the at least one condition rule; and application data accessed by the application for the user in applying the at least one condition rule.

3. A filter as claimed in claim 2, wherein the application data for the user comprises at least one of: historical data; and account balance data.

4. A filter as claimed in claim 1, further comprising an input adaptor configured to receive and process the access request to provide the request data for the rules engine.

5. A filter as claimed in claim 1, wherein the filter is configured to invoke a two-factor authentication process for confirming the identity of the user when the condition is detected.

6. A filter as claimed in claim 1, wherein the rules engine is further configured to determine at least one of: i) an Internet Protocol (IP) address associated with the access request, ii) a change between the request data and previous request data representing a previous access request from the user; iii) a location associated with the IP address, iv) a distance between the location and a previous location associated with a previous IP address associated with the previous access request, v) a speed from the distance, a receive time of the access request and a previous receive time of the previous access request, vi) a client parameter of a client application used to generate the access request and vii) a change in the client parameter between the access request and a previous access request.

7. A filter as claimed in claim 6, wherein the client parameter is the version of a Web browser used to generate the access request.

8. A filter as claimed in claim 6, wherein the rules engine is further configured to determine a blacklist match between the IP address and an IP address blacklist.

9. A filter as claimed in claim 1, wherein the rules engine is further configured to determine at least one of: i) a connection speed associated with the access request, ii) a speed change between the connection speed and a previous connection speed associated with a previous access request, iii) connection type associated with the access request and iv) a connection type change between the connection type and a previous connection type associated with a previous access request.

10. A filter as claimed in claim 9, wherein the rules engine is further configured to determine at least one of: i) when the access request is associated with a public hot-spot connection and ii) when the access request is associated with a satellite connection.

11. A filter as claimed in claim 1, wherein the probability level is generated using data produced by applying the at least one condition rule.

12. A filter as claimed in claim 1, wherein the rules engine is further configured to deny access to the application for the user when the condition is detected.

13. A filter as claimed in claim 1, wherein the filter is configured to invoke an alert generation process for alerting a party when the condition is detected, before passing the access request to the application.

14. A filter as claimed in claim 13, wherein the alert generation process comprises generating an email alert or an SMS alert.

15. A filter as claimed in claim 1, wherein the rules engine is further configured to: generate a first probability level by applying a first condition rule to the request data; select a second condition rule based on the first probability level; and apply the second condition rule to the request data for generating a second probability level.

16. A management server for generating an interface to adjust and set at least one condition rule, wherein the management server comprises:
a filter installed in an application server including a secure application, the filter comprising a rules engine configured to i) receive request data representing an access request for the application from a user, ii) apply at least one condition rule to the request data for generating a probability level, and iii) detect at least one condition when the probability level exceeds a threshold level, before passing the access request to the application.

17. A management server as claimed in claim 16, wherein the interface comprises tools to adjust the dependence and connections between condition rules used to generate the probability level.

18. A filter system comprising:
a filter installed in an application server including a secure application, the filter comprising a rules engine configured to i) receive request data representing an access request for the application from a user, ii) apply at least one condition rule to the request data for generating a probability level, and iii) detect at least one condition when the probability level exceeds a threshold level, before passing the access request to the application; and
a management server configured to generate an interface to adjust and set the at least one condition rule.

19. An application server including:
an application for access by a user; and
a filter installed in an application server including a secure application, the filter comprising a rules engine configured to i) receive request data representing an access request for the application from a user, ii) apply at least one condition rule to the request data for generating a probability level, and iii) detect at least one condition when the probability level exceeds a threshold level, before passing the access request to the application.

20. A method of detecting a condition, performed by an application server, the method comprising:
receiving request data representing an access request from a user for an application of the application server;
applying at least one condition rule to the request data for generating a probability level; and
detecting the condition when the probability level exceeds a threshold level, before granting access to the application.

21. A method as claimed in claim 20, further comprising: applying the at least one condition rule to subsequent access requests during a transaction session with the application before passing the access requests to the application.

22. A method as claimed in claim 20, wherein the applying the at least one condition rule comprises accessing past transaction session data for the user.
